(19) United States
(12) Patent Application Publication
(10) Pub. No.: US 2020/0139642 A1
(43) Pub. Date: May 7, 2020

(54) GLASS AND CARBON FIBER COMPOSITES AND USES THEREOF

(71) Applicant: E.I. Dupont De Nemours and Company, Wilmington, DE (US)

(72) Inventors: Bryan Benedict Sauer, Wilmington, DE (US); Martyn Douglas Wakeman, Gland (CH)

(21) Appl. No.: 15/537,697

(22) PCT Filed: Dec. 2, 2015
(86) PCT No.: PCT/US15/63547

§ 371 Date: Jun. 19, 2017

Related U.S. Application Data
(60) Provisional application No. 62/093,034, filed on Dec. 17, 2014.

(51) Int. Cl. B29C 70/08; B29C 70/34; B32B 5/02; B32B 5/12; B32B 5/26

(52) U.S. Cl. CPC B29C 70/083; B29C 70/34; D03D 15/0011; B32B 5/12; B32B 5/26; B32B 5/024

(57) ABSTRACT

The present invention relates to novel glass-carbon composites presenting very high directional properties in the UD carbon layer direction greater with improved failure mode as compared to full carbon fiber and standard composite fibers. The invention further relates to a process of preparation of such glass-carbon composites and to articles made from such glass-carbon composites.

### FIELD OF THE INVENTION

This invention relates to glass fiber (GF) and carbon fiber (CF) composites for use in composite structures, for instance for use in automotive, industrial, consumer, or aerospace applications.

### BACKGROUND OF THE INVENTION

With the aim of replacing metal parts for weight saving and cost reduction while having comparable or superior mechanical performance, structures based on composite materials comprising a polymer matrix containing a fibrous material have been developed.

In highly demanding applications, such as for example structural parts in automotive and aerospace applications, composite materials are desired due to a unique combination of light weight, high strength and temperature resistance.

High performance composite structures can be obtained using thermosetting resins or thermoplastic resins as the polymer matrix. Thermoplastic-based composite structures present several advantages over thermoset-based composite structures including the ability to be post-formed or reprocessed by the application of heat and pressure. Additionally, less time is needed to make the composite structures because no curing step is required and they have increased potential for recycling.

In particular, composite structures comprising fibrous material made of carbon fibers are particularly interesting in that the carbon fibers confer very good mechanical properties to the material. In particular, carbon composites have excellent weight specific properties due to the high fiber modulus but in many applications are considered to be too expensive when used alone. A further drawback of long carbon fiber (CF) or continuous CF thermosets in certain applications is that they may be too brittle. Thermoplastic CF composites are believed to be tougher, as are thermoplastic CF/glass fiber (GF) hybrid multilayer laminates, yet, with the very high fiber loadings needed for high modulus and strength, the composites still have low load retention after initial failure in flexural testing. Moreover, the impregnation of fibrous material made of carbon fibers with thermoplastic polymer resins can be particularly challenging. This is particularly true with fibrous material made of carbon fibers with high basis or areal weight, in part due to the fact that carbon fibers have a smaller fiber diameter and a large number of fibers per bundle, but also due to the moderate incompatibility of carbon fibers with polar polymers such as polyamides due to the low polarity of carbon fibers.

Therefore, composite manufacturers are facing the dilemma that end applications need increased stiffness as compared to glass fiber composite but at lower costs than full carbon fiber, while significant energy absorption properties are needed where it is advantageous and desired to enable load triggering and tailored rip-through in the part where high levels of force can be maintained for greater displacements.

### SUMMARY OF THE INVENTION

It is an aim of this invention to provide a carbon fiber based composite material that has a high stiffness yet has a high energy absorption ability and strain to rupture.

It is another aim of the invention to provide an article made from a carbon fiber based composite material that has a high strength to weight ratio and that has a high energy absorption ability and strain to rupture.

It is advantageous to provide a carbon fiber based composite material, and articles made therefrom, that are economical to produce.

It is advantageous to provide a carbon fiber based composite material, and articles made therefrom, that have consistent and reliable properties.

Objects of this invention have been achieved by providing the process according to claim 1 and the composite material according to claim 19 or 23.

Disclosed herein is a process for preparing a glass and carbon fiber composite structure comprising:

stacking at least one layer of fibrous material made of glass fibers against at least one layer of unidirectional (UD) carbon fiber tape;

the UD carbon fiber tape comprising unidirectional carbon fibers pre-impregnated with a thermoplastic resin;

applying heat at a temperature adapted to melt the thermoplastic resin;

applying pressure for a short time to the heated stacked layers to bond together and fully impregnate both carbon fiber and glass fiber layers in resin and subsequently cooling the stacked layers to harden the thermoplastic resin to form said composite structure.

In an advantageous embodiment, the layer of fibrous material made of glass fibers is resin free prior to the heating step. The fibrous material made of glass fibers is preferably woven, however in embodiments of the invention the glass fiber material may also be non-woven.

The process may further comprise stacking at least one thermoplastic resin layer adjacent to said at least one layer of fibrous material made of glass fibers prior to the heating step.

The amount of resin provided in the stacked layers may advantageously be selected such that the composite structure has a resin weight fraction to total weight of between 25 and 40 wt %.

The amount of fibrous material made of glass fibers provided in the stacked layers is preferably selected such that the volume fraction of glass to total fiber volume fraction in the composite structure is less than 0.6.
In an embodiment, the carbon fiber content provided in the stacked layers is configured such that the carbon volume weight fraction relative to total volume of carbon fiber and resin within carbon fiber regions of the composite structure after the cooling step is between 35 and 49 vol %.
In an embodiment, the composite structure may comprise a plurality of pairs of fibrous glass fiber and UD carbon fiber tape layers.

In an embodiment, the process may comprise stacking at least one thermoplastic resin layer adjacent to each layer of fibrous material made of glass fibers prior to the heating step.

In an embodiment, the composite structure may comprise between 2 to 10 layers of UD carbon fiber tape.

In an embodiment, the composite structure may comprise between 2 to 6 layers of fibrous material made of glass fibers.

In an embodiment, the composite structure may advantageously comprise at least 2 consecutive layers of UD carbon fiber tape on the outer surface of the composite structure.

In an embodiment, each layer of fibrous material made of glass fibers has a basis weight greater than 190 g/m2 and less than 800 g/m2, preferably between 250 g/m2 and 650 g/m2.

In an embodiment, each layer of resin impregnated unidirectional (UD) carbon fiber tape has a basis weight greater than 90 g/m2 and less than 450 g/m2.

In an embodiment, the stacking step may comprise stacking a plurality of layers of fibrous material comprising at least two resin impregnated unidirectional (UD) carbon fiber tapes and at least one glass fiber layer sandwiched between said at least two UD carbon fiber tapes, and wherein after the cooling step the volume percentage of carbon fiber relative to the total volume in representative carbon fiber regions comprising at least 300 fibers is in the range of between 35 and 49 vol % carbon fiber, preferably in the range of between 39 and 47 vol % carbon fiber, and a volume fraction of glass to total fiber volume fraction within the entire laminate less than 0.6.

Also disclosed herein is a composite material structure comprising a plurality of stacked layers of fibrous material embedded in a resin, said plurality of layers of fibrous material comprising at least two carbon fiber layers and at least one glass fiber layer sandwiched between said at least two carbon fiber layers, wherein the carbon fiber layers originate from a resin impregnated unidirectional carbon fiber tape, and wherein the volume percentage of carbon fiber in representative carbon fiber regions relative to the total volume in these representative carbon fiber regions comprising bundles of at least 300 carbon fibers, is in the range of between 35 and 49 vol % carbon fiber preferably between 39 and 47 vol % carbon fiber.

In an embodiment, the volume percentage of carbon fiber relative to the total volume, within a continuous region of the composite structure encompassing at least 300 carbon fibers and comprising essentially only carbon fibers and resin, is in the range of between 39 and 47 vol % carbon fiber. The continuous region may be essentially arbitrarily selected and forms a measure of the degree of homogeneity of the distribution of carbon fibers in the carbon fiber layers or regions of the composite structure. This high homogeneity of distribution of the carbon fibers in the composite structure of the invention including glass fiber layer(s), is one of the reasons for the advantageous combination of high flex strain and high flexural modulus, compared to conventional composite materials.

In the invention, the choice of starting materials in the laminate stack, in particular the combination of pre-impregnated unidirectional carbon fiber tape layers, glass fiber layer(s), preferably dry (resin free) woven glass fiber layer(s), and resin layers, allows to optimally control the distribution of fibers and resin to obtain enhanced flexural stress and strain to rupture properties compared to prior art processes and resulting composite structures.

In an embodiment, the composite material structure may comprise UD carbon fiber tape layers on opposed outer surfaces of the composite structure, presenting a flexural modulus of about 60 GPa or higher and a percentage retention of peak stress at 5% flex strain of at least about 60%.

In another embodiment, the composite material structure may comprise woven glass fabrics on opposed outer surfaces of the composite structure, presenting a flexural modulus of about 35 GPa or higher and a percentage retention of peak stress at 5% flex strain of at least about 20%.

Also disclosed herein is a composite material structure comprising a plurality of stacked layers of fibrous material embedded in a resin, said plurality of layers of fibrous material including at least two carbon fiber layers and at least one glass fiber layer sandwiched between said at least two carbon fiber layers, wherein the carbon fiber layers originate from a resin impregnated unidirectional carbon fiber tape, and wherein the composite material structure is characterized by a flex modulus of 60 GPa or higher and a percentage retention of peak stress at 5% flex strain of at least 60%.

The composite material structure may advantageously comprise a volume percentage of carbon fiber relative to the total volume, within a continuous region of the composite structure encompassing at least 300 carbon fibers and comprising essentially only carbon fibers and resin, is in the range of between 35 and 49 vol % of carbon fiber, preferably in the range of between 39 and 47 vol % carbon fiber.

In embodiments of the invention, the resin may advantageously comprise a polyamide resin.

In an embodiment of the invention, each carbon fiber layer may have a basis weight between 90 g/m² and 450 g/m².

In an embodiment of the invention, each glass fiber layer may have a basis weight between 190 g/m² and 800 g/m², in particular between 250 g/m² and 650 g/m².

In a composite material according to embodiments of the invention, more resin is observed within representative carbon fiber (CF) region and less within the glass fiber (GF) layer in the laminate compared to conventional composite CF/GF materials. For an equivalent total quantity of resin in the overall laminate the invented composite differs from conventional composites in how the resin is distributed in the carbon and glass fiber regions. In the laminates of conventional composites, the resin films take the preferred path in early stages of melt pressing migrating to the higher permeability/more porous and more polar glass fabric regions first, and thus the glass fabric regions have a higher resin fraction than in the laminates of composites of the invention while the carbon regions have a lower resin content (while still being fully impregnated). In a composite materials according to the invention, this lower CF vol % within the CF bundles makes these CF bundles tougher and much less sensitive to premature in-plane splitting or delamination of the CF bundles, thus avoiding the early catastrophic load drop after the force peak during flexural loading observed for conventional composite CF/GF material examples.

Experimental data supports that in composites of the invention where the unidirectional CF bundles are already pre-impregnated with the thermoplastic resin in the form of UD CF tape, during thermal pressing of the layers, capillary forces trap the resin within the carbon fibers of the tape and keep it from migrating out into the glass fabric regions such that within the selected carbon fiber layer the carbon fiber represents between 35 and 49 vol % in the layer of the composite which are believed to explain the improved stiffness and strain to failure as compared to known composites.

The invention thus relates to the unexpected findings of novel glass-carbon composites with high flexural modulus and excellent strain to complete failure and retention of load at strain levels well above the maximum force peak. Such composites with those improved properties have practical applications where high stiffness in addition to high energy absorption are needed such as crash protection in automotive and other applications. It has been unexpectedly found that the use of carbon fiber unidirectional tapes (UD carbon fiber tape), formed of long strands of unidirectional continuous carbon fiber impregnated with a thermoplastic resin in a continuous pultrusion or other such tape production process including melt coating and powder impregnation (with the objective being to prefabricate an impregnated UD tape of carbon fiber and polyamide), in the forming of a glass and carbon fiber composite material, allows a good distribution of the resin to be obtained within the material across the fiber length, avoiding the formation of clusters of resin rich areas which then limit the ability to carrying load. This also leads to an increase in the carbon fiber straightness in the direction of the carbon fiber layer length in comparison to the use of dry carbon fiber or other carbon fiber preparations as a starting material in the stacking and heat forming process. The stacking of carbon fiber and glass fiber layers to form laminates and the heat forming process after stacking the layers together can use standard procedures (e.g. using double belt press, continuous molding etc. . . . ). The invention provides a more homogeneous material not only across the width of the layers but also through the layers.

According to another aspect of the invention, the properties of the novel glass-carbon composites of the invention present very high directional properties in the UD carbon layer direction which are greater than in a full carbon fiber balanced 2-2 twill weave for example, while presenting transverse properties equivalent to conventional glass fibers and leading to an improved failure mode with higher strain to rupture compared with conventional glass-carbon hybrids.

The properties of the composite of the invention are particularly unexpected since carbon fibers are known to be stiffer than glass fiber composites but to have lower strains to failure than glass composites (for instance 1.5% for Zoltek PANEX 35 carbon fiber, 2.1% for Toray T700s carbon fiber, compared with 4.5% for E-glass fiber). The gain in stiffness and performance at peak force shown by the glass carbon composite of the invention, while providing a composite at lower cost than with carbon fiber alone, is surprising.

Further objects and advantageous aspects of the invention will be apparent from the claims, and from the following detailed description and accompanying figures.

### BRIEF DESCRIPTION OF THE DRAWINGS

FIG. 1 reports various compositions of the composites of the invention and comparative examples together with their mechanical properties as described in Example 1 below. The order of the layers in the laminate stack are represented by the specific sequence of the layers wherein C stands for the layer made of carbon and G stands for the layer made of glass fibers.

FIG. 2 is a representation of typical composite structure consisting of alternating thermoplastic resin layers with resin-free fibrous (carbon and glass) layers used for the Comparative Examples (FIG. 2A) as compared to a typical composite structure designed in composites of the invention using resin pre-impregnated UD CF tape, and a few thermoplastic resin layers only positioned adjacent to the resin-free glass fabric layers (Ex. 1-12) (FIG. 2B).

FIG. 3 represents the Flexural stress versus strain in 3-point-bending tests as described in Example 1 for a composite of the invention (Ex. 1) as compared to a comparative composite Comp. A and B (3A) and for a composite of the invention (Ex. 1) as compared to a 100% carbon fiber composite structure (Comp. F) (3B).

FIG. 4 represents typical micrographs of a cross section of a laminate of a composite of the invention (Ex. 1) (FIG. 4A) as compared to a cross section of a laminate of a comparative composite (Comp. A) observed by microscopy at ×215 magnification as described in Example 2. As described herein, fiber volume fractions within these representative carbon fiber regions from groups of 300-500 fibers were determined as averages of about ten such images taken from different representative regions of the laminate cross section. The carbon bundle regions only are shown, and a representative region of about 300 fibers is indicated in each image by the black rectangle. The section was made perpendicular to the fiber axis. Ex 1 (FIG. 4A) and Comp A (FIG. 4B) both have total laminate carbon fiber weight fractions relative to the total laminate weight of 40-43%.

FIG. 5 represents schematically the observed patterns in cross sections of composite laminates of the invention made of pre-impregnated UD CF tape (FIG. 5B) as compared to a cross section of a laminate of a comparative composite made of UD non-crimp carbon fabric (UD NCF) with an area weight of dry fiber of 150 g/m² (FIG. 5A). Both have total laminate carbon fiber weight fractions relative to the total laminate weight of about 40-43%. The carbon fibers' orientation is perpendicular to the plane. The bottom and top layers are regions of the carbon fiber bundles and the center layer is a thermoplastic resin glass layer, where the glass fibers have a diameter of nominally 17 μm in diameter. The volume fraction (vol %) fiber of the carbon and glass fiber in the representative carbon or glass fiber regions are indicated next to each layer in this schematic representation.

FIG. 6 illustrates beams (A & B) molded from a flat sheet of composite material according to embodiments of the invention and of comparative material which were then over-molded with a short fiber filled resin and the test on mechanical properties (extending testing bed) of a beam made of a laminate sheet of a composite of the invention as compared to a laminate sheet made of a comparative composite as described in example 3 (B & C).

### DETAILED DESCRIPTION OF EMBODIMENTS OF THE INVENTION

For purposes herein, the term “fiber” is defined as a macroscopically homogeneous body having a high ratio of length to width across its cross-sectional area perpendicular to its length. The fiber cross section can be any shape, but is typically round or oval shaped.

Fibrous layer basis weight refers to the weight per unit area of the dry fibrous layer.

The filament count in a fiber tow is useful in defining a carbon fiber tow size. Common sizes include 12,000 (12 k) filaments per tow, or 50,000 (50 k) filaments per tow.

As used herein, the term resin pre-impregnated unidirectional carbon tape is per se well known to the skilled person and can be made using melt pultrusion, powder or film impregnation, or many other methods. The resin is spread throughout the cross section of the tape rather than an agglomeration or coating at the outside or surrounding the carbon fibers. Any voids present in the structure are randomly distributed rather than a preferential area which has an intended lack of resin or impregnation.

As used herein, the term “impregnated” means the resin composition flows into the cavities and void spaces of the fibrous material. For example, the quality and level of impregnation can be assessed and measured by determining the void content.

Voids can be were measured as described in the Examples.

As used herein, the term fibrous material made of glass fibers, encompass woven or non-woven structures (e.g., mats, felts, fabrics and webs) textiles, fibrous battings, a mixture of two or more materials, and combinations thereof. Non-woven structures can be selected from random fiber orientation or aligned fibrous structures. Examples of random fiber orientation include without limitation material which can be in the form of a mat, a needled mat or a felt. Examples of aligned fibrous structures include without limitation unidirectional fiber strands, bidirectional strands, multidirectional strands, multi-axial textiles. Textiles can be selected from woven forms, knits, braids and combinations thereof.

In a process for preparing a composite structure according to the invention, according to a particular aspect, the layer of glass fibrous material is a resin free glass fiber layer.

According to another particular aspect, a thermoplastic resin layer is placed adjacent to a layer of resin-free glass fibrous material before subjecting the stacked layers to a thermal forming treatment.

According to an advantageous embodiment, the stack of layers prior to the thermal forming treatment step comprises between 2 to 10 layers of UD carbon fiber tape.

According to an advantageous embodiment, the stack of layers prior to the thermal forming treatment step comprises between 2 to 6 layers of fibrous material made of glass fibers.

According to a further particular embodiment, the process for preparing a composite structure of the present invention comprises stacking at least 2 consecutive layers of UD carbon fiber tape on the outer surface of the composite structure.

The thermal forming treatment comprises subjecting the stack of layers to heat and pressure to melt the resin in the UD carbon fiber tape and in any additional resin layers to cause impregnation of all the fiber layers to form a composite structure.

According to a further particular aspect, in the process for preparing the composite structure of the present invention, the thermal treatment step is conducted until the obtaining of a composite structure having a void content of less than 2%, during a period of time of less than 2 minutes at temperatures above 320° C., for example between 320° C. and 350° C., for example between 360° C. and 390° C., and pressures above 20 bars.

Pressure used during the thermal treatment can be applied by a static process or by a continuous process (also known as a dynamic process), a continuous process being preferred for reasons of speed. Examples of stacking processes include without limitation vacuum molding, in-mold coating, cross-die extrusion, pultrusion, wire coating type processes, lamination, stamping, diaphragm forming or press-molding, lamination being preferred.

The process for preparing a composite structure of the present invention comprises a further step of cooling and subsequently recovering the formed composite structure after the subjecting of the stacked layers to heat and pressure.

One example of a method used in the thermal treatment step is a lamination process. The first step of the lamination process involves heat and pressure being applied to the layered structure through opposing pressured rollers or belts in a heating zone, preferably followed by the continued application of pressure in a cooling zone to finalize consolidation and cool the obtained composite structure by pressurized means. Examples of lamination techniques include without limitation calendaring, flatbed lamination and double-belt press isobaric or isochoric lamination. Laminates of composite structure according to the invention can be made using a lamination process such as using a double belt press (DBP) or a continuous compression molding (CCM) or batch press to make a pre-made sheet form, for example such as described in Example 1. According to one aspect, when lamination is used as the stacking step, preferably a double-belt press is used for lamination, and more preferably an isobaric DBP.

Alternatively, the thermal treatment step can be made by “co-stamping”, i.e. the pre-impregnated UD carbon fiber tapes and the fibrous material made of glass fibers are heated in an oven above melt temperature and then transferred to a molding tool where the pre-impregnated UD carbon fiber tapes and the fibrous material made of glass fibers are combined in an alternation of layers as described herein and pressed together, forming a composite structure of the invention during the part forming process.

According to one aspect, the composite structure of the invention can be pre-made as a sheet, or formed as a composite directly in the part-making process. Such composite structure can be used as a material that covers the bulk of the component for an over-all stiffening effect, or for use as strips or local patches where stiffening is needed only in local areas, either in a bulk glass fiber composite with continuous fibers, or in a discontinuous fiber composite for example combining i) injection molding with local patches or strips of composite structure of the invention, or ii) co-compression of Direct long-fiber thermoplastic (D-LFT) material with local patches or strips of composite structure of the invention.

One example of a method used in the thermal treatment step is a thermopressing step made at a pressure between about 2 and 100 bars and more particularly between about 10 and 40 bars and a temperature which is above the melting point of the resin, preferably at least about 20° C. above the melting point to enable a proper impregnation. Heating may be done by a variety of means, including contact heating, radiant gas heating, infrared heating, convection or forced convection, induction heating, microwave heating or combinations thereof.

According to another further particular aspect, is provided a composite structure obtainable by a process according to the invention.

According to a particular aspect, is provided a composite structure comprising:
a) two or more fibrous layers made of resin impregnated carbon UD fiber tapes with a basis weight greater than or equal to 90 g/m²;
b) one or more layer of a fibrous material made of glass fibers with a basis weight greater than or equal to 190 g/m² and
   wherein both the fibrous materials made of carbon and glass fibers are impregnated with the resin and wherein between about 35 and 49 vol % CF fiber are present in the carbon UD fiber bundles, notably between 39 and 47 vol % CF fiber.

According to another particular aspect, the resin wt % (based on the total weight of the composite structure) is equal or higher to about 28 in a composite of the invention.

According to another further particular aspect, is provided a composite structure wherein the resin wt % is between about 30 to about 40 in a composite of the invention.

According to a another further particular aspect, is provided a composite structure characterized by a flex modulus of about 80 GPa or higher and a percentage retention of peak stress at 5% flex strain of at least about 60%.

According to another further particular aspect, is provided a composite structure characterized by a flex modulus of about 50 GPa or higher and a percentage retention of peak stress at 8% flex strain of at least about 20%.

According to another further particular aspect, is provided a glass carbon composite structure with carbon tape layers on both outside surfaces characterized by a flex modulus of about 60 GPa or higher and a percentage retention of peak stress at 5% flex strain of at least about 60%.

According to another further particular aspect, is provided a glass carbon composite structure with glass fiber layers on both outside surfaces characterized by a flex modulus of about 35 GPa or higher and a percentage retention of peak stress at 5% flex strain of at least about 20%.

According to another further particular aspect, the fibrous material made of glass fibers has a basis weight greater than or equal to 190 g/m², in particular greater than 190 g/m² and less than 800 g/m², for example greater or equal to 250 g/m², for example between about 250 and 600 g/m² and particularly greater than or equal to 500 g/m².

According to another further particular aspect, the resin impregnated carbon UD fiber tapes have a basis weight greater than or equal to 90 g/m², in particular greater than or equal to 150 g/m² and less than 450 g/m² for example between about 150 and 170 g/m².

According to another further particular aspect, the composite structure of the invention at least one pre-impregnated UD carbon fiber tape layer is present on the outer surfaces of the composite structure of the invention.

According to another further particular aspect, the composite structure of the invention contains three layers of fibrous material with the following arrangement: C/G/C, wherein C stands for the pre-impregnated UD carbon fiber tape layer made and G stands for the layer made of glass fibers, where the glass fiber layer is optionally surrounded by a different thermoplastic resin or a thermosetting resin layer.

According to another further particular aspect, the composite structure of the invention contains five layers of fibrous material with the following arrangement: C/C/G/CC or C/G/C/G/C, wherein C stands for the pre-impregnated UD carbon fiber tape layer made and G stands for the layer made of glass fibers, where the glass fiber layer is optionally surrounded by a different thermoplastic resin or a thermosetting resin layer.

According to another further particular aspect, the composite structure of the invention contains seven layers of fibrous material with the following arrangement: C/C/C/G/C/C/C or C/G/C/G/C/G/C, wherein C stands for the pre-impregnated UD carbon fiber tape layer made and G stands for the layer made of glass fibers, where the glass fiber layer is optionally surrounded by a different thermoplastic resin or a thermosetting resin layer.

According to another further particular aspect, the composite structure of the invention contains arrangements where the outer layer is glass fiber and the inner layers carbon fiber, for example with the following arrangements: G/C/G; G/G/C/G/G; G/C/G/C/G; G/C/C/C/C/G; G/C/C/G/C/C/G; G/C/C/G/C/C/G, wherein C stands for the pre-impregnated UD carbon fiber tape layer made and G stands for the layer made of glass fibers, where the glass fiber layer is optionally surrounded by a different thermoplastic resin or a thermosetting resin layer.

According to another further particular aspect, the thermoplastic resin used in a composite of the invention is a polyamide resin. Polyamide resins suitable in the manufacture of the composite structure of the invention are condensation products of one or more dicarboxylic acids and one or more diamines, and/or one or more aminocarboxylic acids, and/or ring-opening polymerization products of one or more cyclic lactams. The polyamide resins are selected from fully aliphatic polyamide resins, semi-aromatic polyamide resins and mixtures thereof. The term “semi-aromatic” describes polyamide resins that comprise at least some aromatic carboxylic acid monomer(s) and aliphatic diamine monomer(s), in comparison with “fully aliphatic” which describes polyamide resins comprising aliphatic carboxylic acid monomer(s) and aliphatic diamine monomer(s).

Fully aliphatic polyamide resins are formed from aliphatic and alicyclic monomers such as diamines, dicarboxylic acids, lactams, aminocarboxylic acids, and their reactive equivalents. A suitable aminocarboxylic acid includes 11-aminododecanoic acid. In the context of this invention, the term “fully aliphatic polyamide resin” refers to copolymers derived from two or more such monomers and blends of two or more fully aliphatic polyamide resins. Linear, branched, and cyclic monomers may be used. Star polymers may also be used.

Carboxylic acid monomers useful in the preparation of fully aliphatic polyamide resins include, but are not limited to, aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Useful diamines include those having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine and/or mixtures thereof. Suitable examples of fully aliphatic polyamide resins include PA6; PA6,6; PA4,6; PA6,10; PA6,12; PA6,14; P 6,13; PA 6,15; PA6,16; PA11; PA 12; PA10; PA 9,12; PA9,13; PA9,14; PA9,15; PA6,16; PA9,36; PA10,10; PA10,12; PA10,13; PA10,14; PA12,10; PA12,12; PA12,13; PA12,14 and copolymers and blends of the same.

Semi-aromatic polyamide resins are homopolymers, copolymers, terpolymers, or higher polymers wherein at least a portion of the acid monomers are selected from one or more aromatic carboxylic acids. The one or more aromatic carboxylic acids can be terephthalic acid or mixtures of terephthalic acid and one or more other carboxylic acids, like isophthalic acid, substituted phthalic acid such as for example 2-methylterephthalic acid and unsubstituted or substituted isomers of naphthalenedicarboxylic acid, wherein the carboxylic acid component preferably contains at least 55 mole percent of terephthalic acid (the mole percent being based on the carboxylic acid mixture). Preferably, the one or more aromatic carboxylic acids are selected from terephthalic acid, isophthalic acid and mixtures thereof and more preferably, the one or more carboxylic acids are mixtures of terephthalic acid and isophthalic acid, wherein the mixture preferably contains at least 55 mole percent of terephthalic acid. Furthermore, the one or more carboxylic acids can be mixed with one or more aliphatic carboxylic acids, like adipic acid; pimelic acid; suberic acid; azelaic acid; sebacic acid and dodecanedioic acid, adipic acid being preferred. More preferably the mixture of terephthalic acid and adipic acid comprised in the one or more carboxylic acids mixtures of the semi-aromatic polyamide resin contains at least 25 mole percent of terephthalic acid. Semi-aromatic polyamide resins comprise one or more diamines that can be chosen among diamines having four or more carbon atoms, including, but not limited to tetramethylene diamine, hexamethylene diamine, octamethylene diamine, nonamethylene diamine, decamethylene diamine, 2-methylpentamethylene diamine, 2-ethyltetramethylene diamine, 2-methyloctamethylene diamine; trimethylhexamethylene diamine, bis(p-aminocyclohexyl)methane; m-xylylene diamine; p-xylylene diamine and/or mixtures thereof. Suitable examples of semi-aromatic polyamide resins include poly(hexamethylene terephthalamide) (polyamide 6,T), poly(nonamethylene terephthalamide) (polyamide 9,T), poly (decamethylene terephthalamide) (polyamide 10,T), poly(dodecamethylene terephthalamide) (polyamide 12,T), hexamethylene adipamide/hexamethylene terephthalamide copolyamide (polyamide 6,T/6,6), hexamethylene terephthalamide/hexamethylene isophthalamide (6,T/6,I), poly(m-xylylene adipamide) (polyamide MXD,6), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T), hexamethylene adipamide/hexamethylene terephthalamide/hexamethylene isophthalamide copolyamide (polyamide 6,6/6,T/6,I); poly (caprolactam-hexamethylene terephthalamide) (polyamide 6/6,T) and copolymers and blends of the same, in particular PA6,T; PA6,T/6,6, PA6,T/6,1; PAMXD,6; PA6,T/D,T and copolymers and blends of the same.

Any combination of aliphatic or semi-aromatic polyamides can be used as the polyamide for the polyamide matrix resin composition, polyamide surface resin composition, and the polyamide resin of the second component. It is within the normal skill of one in the art to select appropriate combinations of polyamides depending on the end use.

The polyamide resin composition may further comprise one or more common additives, including, without limitation, ultraviolet light stabilizers, flame retardant agents, flow enhancing additives, lubricants, antistatic agents, coloring agents (including dyes, pigments, carbon black, and the like), nucleating agents, crystallization promoting agents and other processing aids or mixtures thereof known in the polymer compounding art.

Fillers, modifiers and other ingredients described above may be present in amounts and in forms well known in the art, including in the form of so-called nano-materials where at least one of the dimensions of the particles is in the range of 1 to 1′000 nm.

Preferably, any additives used in the polyamide resin composition are well-dispersed within the polyamide resin. Any melt-mixing method may be used to combine the polyamide resins and additives of the present invention. For example, the polyamide resins and additives may be added to a melt mixer, such as, for example, a single or twin-screw extruder; a blender; a single or twin-screw kneader; or a Banbury mixer, either all at once through a single step addition, or in a stepwise fashion, and then melt-mixed. When adding the polyamide resins and additional additives in a stepwise fashion, part of the polyamide resin and/or additives are first added and melt-mixed with the remaining polyamide resin(s) and additives being subsequently added and further melt-mixed until a well-mixed or homogeneous composition is obtained.

According to another further particular aspect the thermoplastic resin used in a composite of the invention is a polyamide resin selected from the group comprising: PA6; PA11; PA12; PA4,6; PA6,6; PA,10; PA6,12; PA10,10; PA6T; PA6I, PA6I/6T; PA66/6T; PAMXD6; PA6T/DT and copolymers and blends of the same.

According to another further particular aspect, the resin has a weight average molecular weight greater than or equal to 15,000 g/mol, and more particularly, a weight average molecular weight greater than or equal to 25,000 g/mol.

According to another further particular aspect, the resin has a melt viscosity at 290° C. of between 10 Pa·s and 200 Pa·s, more particularly of between 50 Pa·s and 150 Pa·s.

According to another further particular aspect, the thermoplastic resin used in a composite of the invention is a PPS resin.

The resin can be applied to the UD carbon fiber for the pre-impregnation process in a form of a conventional resin composition such as a PA66 or a PA66/6 blend (75:25 blend ratio) and the resin composition can be applied to the fibrous materials by conventional means such as for example powder coating, film lamination, extrusion coating or a combination of two or more thereof, provided that the resin composition is applied on at least a portion of the surface of the composite structure. In case of a powder coating process, a polymer powder which has been obtained by conventional grinding methods is applied to the UD carbon fiber. The powder may be applied onto the UD carbon fiber by scattering, sprinkling, spraying, thermal or flame spraying, extruding, printing, or fluidized bed coating methods. Multiple powder coating layers can be applied to the fibrous material. Optionally, the powder coating process may further comprise a step which consists in a post sintering step of the powder on the fibrous material. Subsequently, thermopressing is performed on the powder coated fibrous materials, with an optional preheating of the powder coated fibrous materials outside of the pressurized zone.

The resin can be placed adjacent to a layer of resin-free glass fibrous material made of glass fibers for the formation of the layered structure in a process of the preparation of a composite of the invention in the form of a film which has been obtained by conventional extrusion methods known in the art such as for example blow film extrusion, cast film extrusion and cast sheet extrusion are applied to one or more layers of the fibrous materials, e.g. by layering.

According to a particular embodiment, the article made of the composite of the invention is a beam part.

According to another particular embodiment, the article is a structural component comprising a reinforcing layer made from the composite material of the invention.

Depending on the end-use application, the composite structure may be shaped into a desired geometry or configuration.

One process for shaping the composite structure of the invention comprises a step of shaping the composite structure after the lamination. Shaping the composite structure may be done by compression molding, stamping or any technique using heat and/or pressure, compression molding and stamping being preferred. Preferably, pressure is applied by using a hydraulic molding press. During compression molding or stamping, the composite structure is preheated to a temperature above the melt temperature of the resin composition by heated means and is transferred to a forming or shaping means such as a molding press containing a mold having a cavity of the shape of the final desired geometry whereby it is shaped into a desired configuration and is thereafter removed from the press or the mold after cooling to a temperature below the melt temperature of the resin composition.

The composite structures according to the invention are characterized by very high directional properties in the UD carbon tape direction (greater than a biaxial balanced twill carbon fiber weave for example), while transverse properties are still equivalent to a conventional glass fiber composite. When sheets of such composite structures are molded into a beam part representative of a plurality of automotive, consumer electronics, industrial, and other such components, the advantages are clearly demonstrated, as illustrated in the following examples.

As is well known in the art, such beams could also be prepared by a so called single step process where the composite sheet is heated to above its melting temperature, for example to 290° C. for a PA66/6 (75:25) blend base resin, where forming then occurs directly in the horizontal or vertical over-injection molding machine as the tool (for example at 120-160° C.) closes and molten over-mold resin is injected directly onto the stamping.

Another processing route is the combination of sheet forming and D-LFT processes. Here the composite sheet is heated using an infrared oven. In parallel, an extruder is used to compound dry fiber and matrix resin or pellets of pre-compounded fiber and resin which are then extruded using a die into a molten log. The molten log is then transported with the heated composite sheet, preferably by robot, into a steel molding tool mounted in a vertically acting hydraulic press, for example as exemplified by equipment supplied by the company Dieffenbacher which is well known in the art.

Due to their advantageous properties, the composite structures according to the present invention may be used in a wide variety of applications such as for example components for automobiles, trucks, commercial airplanes, aerospace, rail, household appliances, computer hardware, portable hand held electronic devices, recreation and sports equipment, structural component for machines, buildings, photovoltaic equipment or mechanical devices.

Examples of automotive applications include, without limitation, seating components and seating frames, engine cover brackets, engine cradles, suspension arms and cradles, spare tire wells, chassis reinforcement, floor pans, front-end modules, steering column frames, instrument panels, door systems, body panels (such as horizontal body panels and door panels), tailgates, hardtop frame structures, convertible top frame structures, roofing structures, engine covers, housings for transmission and power delivery components, oil pans, airbag housing canisters, automotive interior impact structures, engine support brackets, cross car beams, bumper beams, pedestrian safety beams, firewalls, rear parcel shelves, cross vehicle bulkheads, pressure vessels such as refrigerant bottles, fire extinguishers, and truck compressed air brake system vessels, hybrid internal combustion/electric or electric vehicle battery trays, automotive suspension wishbone and control arms, suspension stabilizer links, leaf springs, vehicle wheels, recreational vehicle and motorcycle swing arms, fenders, roofing frames and tank flaps.

Examples of household appliances include without limitation washers, dryers, refrigerators, air conditioning and heating. Examples of recreation and sports include without limitation inline-skate components, baseball bats, hockey sticks, ski and snowboard bindings, rucksack backs and frames, and bicycle frames. Examples of structural components for machines include electrical/electronic parts such as for example housings for hand held electronic devices, televisions, screens, and computers.

### EXAMPLES

### Example 1: Examples of Composite Structures of the Invention and Comparative Examples

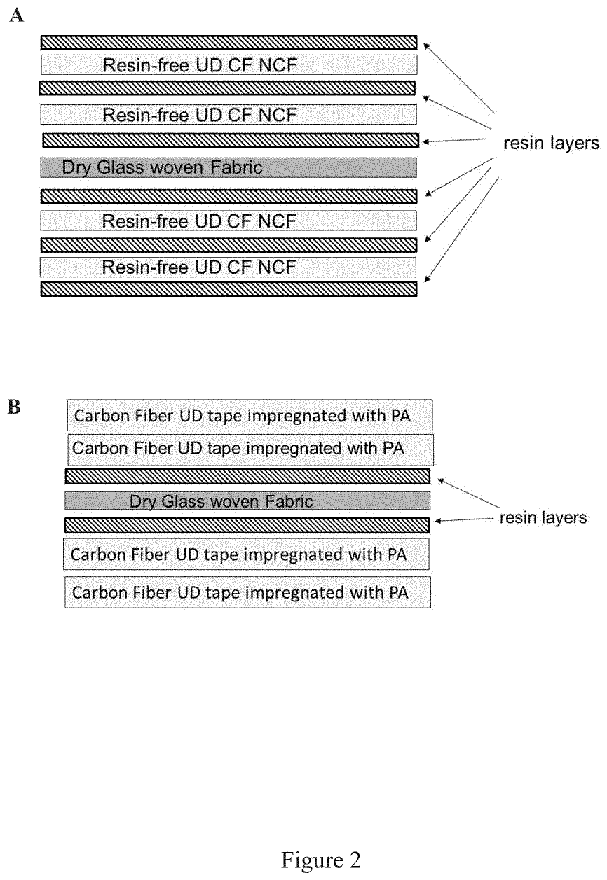

Different composite structures of the invention were prepared according to sequence as described in FIG. 2A and compared to standard composites prepared according to a sequence as described in FIG. 2A.

### Composite of the Invention Ex. 1-12

Pre-impregnated UD carbon fiber tapes were used without the addition of any further PA66 film layer adjacent to the pre-impregnated UD carbon fiber tapes. Film layers of PA66 were added adjacent to the layers of resin-free glass fabric so this fabric could be impregnated during thermal pressing or lamination as described herein.

### Comparative Examples A to E and G-J

Film layers of PA66 were added adjacent to glass fabric and UD CF NCF layers (or woven CF layers) so that all these fibrous layers could be impregnated during thermal pressing or lamination. Lamination was performed under the same conditions used in Ex. 1-12.

Comparative Example F is a 100% carbon fiber (no glass) composite structure comprising 6 layers of UD CF tape all oriented in the same direction. No film layers of PA66 were added. Lamination to consolidate this UD plaque was at 4 minutes at 300° C. and 25 bars.

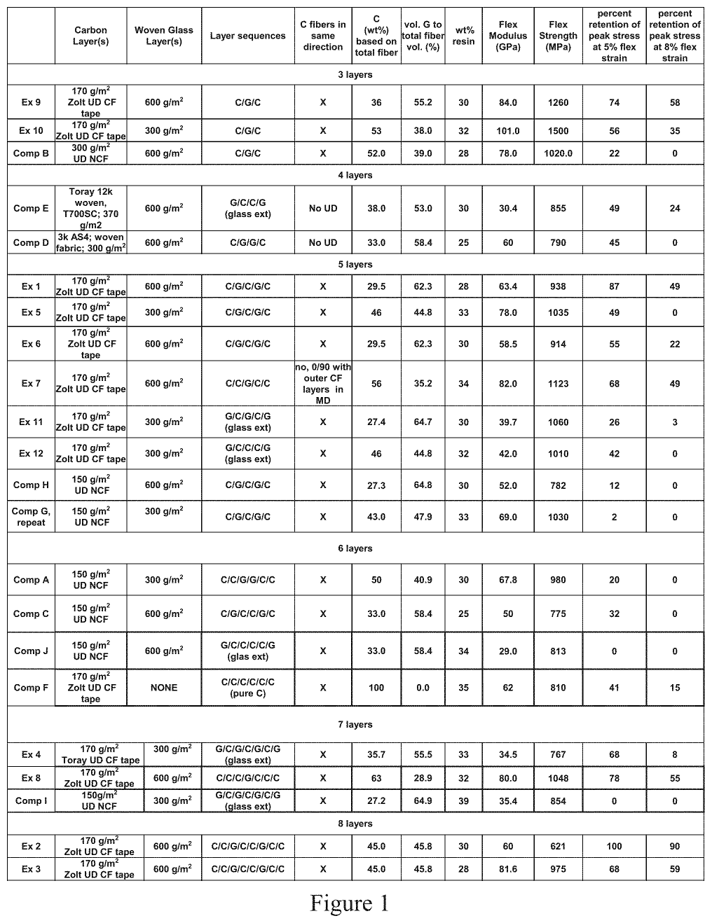

Table of FIG. 1 summarizes compositions of composite structures of the invention (Ex. 1 to Ex. 12) as compared to comparative Examples Com A to Comp J. Composites of the invention are exemplified with different compositions where the following features are varied:
Nature of the woven glass layer used:
   I) a 2-2 balanced twill weave of 600 g/m² areal weight made of 1200tex e-glass of 17 micron diameter supplied by the company PPG
   Ii) a 2-2 balanced twill weave of 290-300 g/m² supplied by the company Hexcel H300 TF970, using filament glass of fiber diameter of 9 μm;
Sequence of the Glass (G) and Carbon (C) fibers from the outer surface to the bottom in the laminate.

In the composite structure of the invention, the carbon layers are made of pre-impregnated unidirectional carbon fiber (UD CF) tape with the carbon fiber comprising (Zoltek PANEX 35, 50 k, i.e. 50,000 filaments per bundle) or Toray (Torey T700s, 12 k, i.e. 12,000 filaments per bundle) (area weight of dry fiber: 170 g/m² with a fiber diameter of 7 μm) wherein the pre-impregnation of the UD CF tape was carried out using a pultrusion process where molten resin was injected into a die over the spread carbon roving to impregnate the carbon fiber from both sides to 35 wt % (or 46 vol. % resin). The resin used was a polyamide (PA) resin made of 75% Nylon 66 (DuPont) and 25% Nylon 6 (Ultramid B27, BASF, Co. (Florham Park, N.J.)). The UD tape was produced by pultrusion using a die that supplied resin to both sides of the spread carbon fiber rovings. The PA66 Mw was 34′000 weight average measured by SECC. The area weight of the carbon fiber tape including the nylon blended resin is 283 g/m²), and the area weight of the hypothetical fiber only component of the tape is 170 g/m².

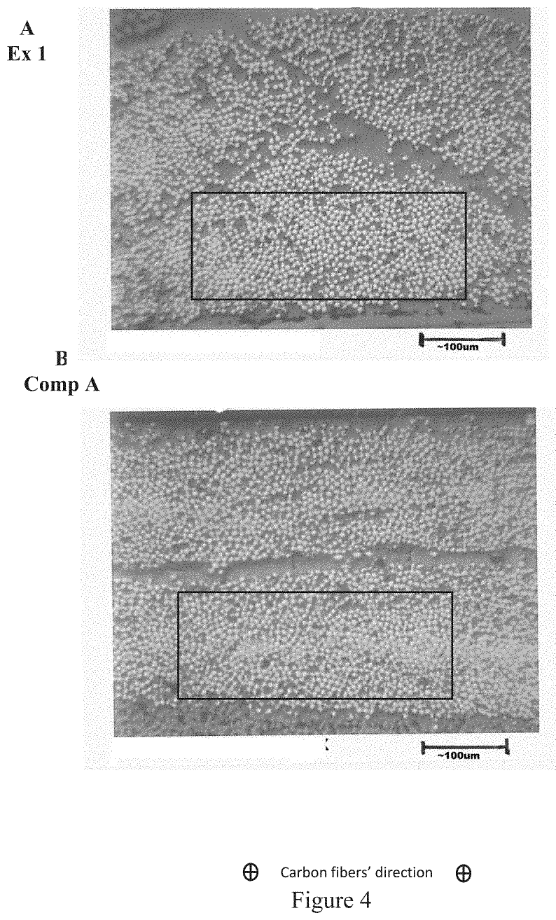

In the comparative examples (Comp. A, B, C, D, E, G, H, I and J), the carbon layers are made of non-pre-impregnated layers respectively as follows:
unidirectional non-crimp carbon fabric (UD NCF) with an area weight of dry fiber of either 150 g/m² (Zoltek 50 k) with a fiber diameter of 7.2 μm
unidirectional non-crimp carbon fabric (UD NCF) with an area weight of dry fiber of either 300 g/m² (Zoltek 50 k) with a fiber diameter of 7.2 μm
woven carbon fabric with an area weight of dry fiber of either 300 g/m² (Hercules 3 k AS4) with a fiber diameter of 7 μm
woven carbon fabric with an area weight of dry fiber of either 370 g/m² (Toray 12 k woven, T700SC) with a fiber diameter of 7 μm.
   In comparative Example F, the composite is made with 100% pre-impregnated 170 g/m² Zoltek UD CF pre-impregnated tape stacked cross-plied (0/90/0/90/0/90) layers without any glass fiber.
   The composite structures were prepared by stacking (thermopressing to less than 2% voids as measured by optical microscopy) layers of resin-free woven glass fabric and their adjacent high performance thermoplastic resin layer polyamide (PA) 66 and carbon fibers (pre-impregnated or with their adjacent high performance thermoplastic resin layer), with the desired sequence arrangement as described in the table of FIG. 1. These composites after consolidation are about 1.0 mm to 1.7 mm thick, depending on the number of layers and basis weights, and the ply stacking sequence or layers could be repeated to make thicker structures.
   Fiber volume fractions within representative carbon fiber regions outside of the glass bundle regions were obtained by analysis of groups of about 300-500 carbon fibers, and these were determined as averages from about ten images like those shown in FIG. 4 taken from different representative regions of the laminate cross section prepared as described next. The images were measured related to the methods in ISO7822 1990(en) following method C, Statistical counting. Samples were prepared for optical microscopy by embedding in resin and polishing to give clear contrast between fiber and resin. Images were taken using an optical microscope to capture multiple images of the sample.

Examples 1-3 and 5 to 12 and Comparative Examples A to J were made by Laminate pressing as follows: Resin films were dried at 90° C. for at least one hour in a model 1410 vacuum oven from VWR International LLC (Radnor, Pa.). Resin films were stacked alternately with carbon fiber and hot-pressed into laminates using a hand-operated hydraulic press model C from Fred S. Carver, Inc. (Summit, N.J.) heated to 340° C. for 1.5 to 2.5 minutes. Following hot-pressing, the laminates were cooled under pressure using a hand-operated hydraulic press model 3912 from Carver, Inc. (Wabash, Ind.) at room temperature. Kevlar® Thermount® paper was used as a frame to mitigate resin squeeze-out during pressing. Removable steel platens of dimension 16.5 cm×20.3 cm and 16.5 cm×15.2 cm were used as interfaces with the laminate. Frekote® 55-NC aerosol spray received from Henkel Corp. (Rocky Hill, Conn.) was used as a mold release agent.

After pressing, laminates were cut to appropriate dimension for flexural mechanical analysis using a MK-377 Tile Saw from MK Diamond Products, Inc. (Torrance, Calif.). Laminate strips were 6 cm long×2 cm wide, with thicknesses of about 0.15 cm. The mechanical properties of the so-obtained laminates are measured by the method for flex mechanical property measurement using 3 point bending following ASTM protocol D790-10 “Standard test methods for flexural properties of unreinforced and reinforced plastics and electrical insulating materials, in particular as follows:
The test speed was 1 mm/min. The Flex modulus is calculated from the slope of the linear region of the representation of the flex stress versus strain, generally below 1.25% strain. The span length to laminate (composite structure) thickness ratio was 16 (span-to-depth ratio of 16:1, where depth refers to the laminate thickness). Samples were dried at 90° C. for 16 hrs, and tested quickly at 20° C. in the dried state without allowing moisture absorption.

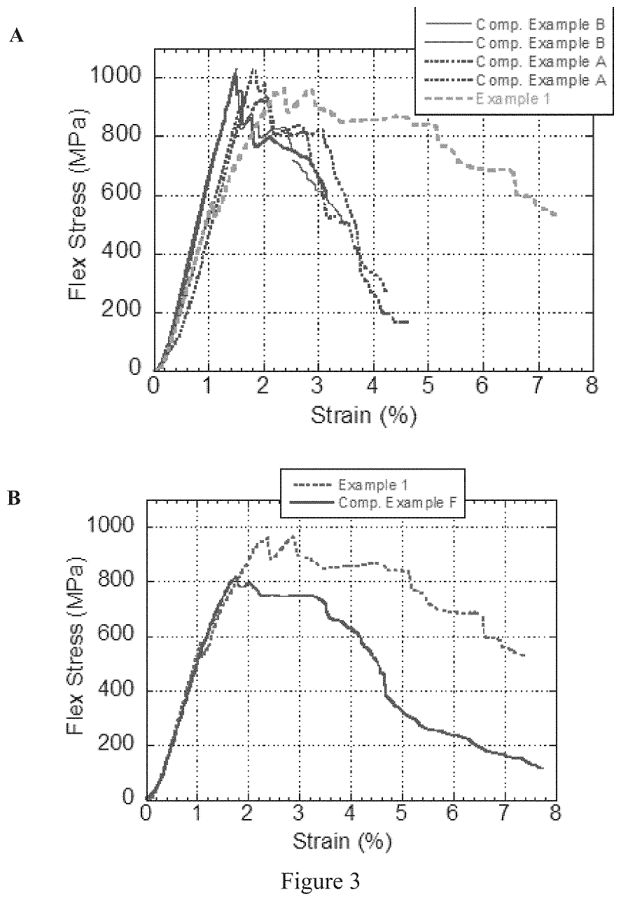

The flex strength (e.g. modulus of rupture or bend strength, defining the material's ability to resist deformation under load) which represents the highest stress experienced within the material at its moment of rupture or partial rupture is determined for each sample as well as the percent retention of peak stress at 5% and 8% flex strain which is deduced from the representation of the Flex Stress versus strain % (FIG. 3). Those parameters are represented on FIG. 1.

The provided data show that laminates obtained by stacking fibrous layers as described in FIG. 2A may present a high flex modulus but do all have a fairly low strain to failure, and when they fail, crack growth leads to rapid decreases in flex stress at strains above 3% (Comp. Examples A-E).

Composites of the invention, where glass layers are combined with pre-impregnated UD CF tape layers containing a polyamide matrix as represented in FIG. 2B, are however characterized by and increased toughness as reflected by flex testing results where very high stress levels are measured after initial fracture out to 5% or 8% strains or more, as seen on the flex mechanical stress-strain curves (FIG. 3). This high stress at high strains occurs with many different layering combinations defined for Examples 1-12 in FIG. 1.

From the data, it can be seen that even with a composite of 3 layers, with carbon layers at the outer surfaces, very high flex modulus and high percentage of stress retained at strains of 5% and 8% are obtained (Examples 8 and 9).

These properties are also observed when increasing the number of layers up to 5, 6 or 7 layers with the carbon layers at the outer surfaces. If one compares composites presenting similar nominal Flex moduli and strengths (Example 1 and Comparative Examples A and B), only the composite with pre-impregnated UD CF tape has a high percentage of stress retained at strains of 5% and 8% (Example 1) whereas the comparative examples with resin-free UD NCF as the CF layers present very poor percent retention of peak stress at 5% already (FIGS. 1 and 3A).

The same conclusions apply if one compares further composites presenting similar nominal Flex moduli and strengths (Example 2 and Comparative Examples C and D), where again only the composite with pre-impregnated UD CF tape has a high percentage of stress retained at strains of 5% and 8% (Example 2) whereas the comparative examples with resin-free UD NCF (Comparative Example C) or woven fabric (Comparative Example C) as the CF layers present very poor percent retention of peak stress at 5% already (FIG. 1).

Even with nominally tougher glass fabric on the outer surfaces, the composite of Comparative Example E (using two layers of initially resin-free woven fabric as glass fiber), does not reach a high percentage of stress retained at strains of 8%, as compared to the composite of the invention of Example 3 with much higher modulus which has a high percentage of stress retained at strains of 5% and 8% (FIG. 1).

For the sake of comparison, a 100% CF UD composite made from UD carbon fiber tape has low percentage of stress retained at strains of 5% and 8% (FIG. 1) which is consistent with findings in the literature where for high modulus, high CF fraction thermoplastic laminates. With such a high modulus, failure becomes abrupt as is seen on FIG. 3B, while in Examples 1, 3, 7 and 8 for very high modulus much higher percentages of stress retained at strains of 5% and 8% are obtained which is unexpected (FIG. 1).

Further, it is also observed that in composites of the invention, the presence of nominally tougher glass fabric layers on the outer surfaces, generally lead to lower flex moduli and lower stress retained at strains of 5% or 8% (Examples 11 and 12 as compared to Examples 1, 5 and 6 and Example 4 as compared to Example 8).

It is also observed that in composites of the invention, the use of woven glass fabric of higher area weight of dry fiber, such as 600 g/m², leads to higher stress retained at strains of 5% or 8% (Example 9 as compared to Example 10 and Example 1 as compared to Example 6).

Finally, as is per se known in the literature, much higher moduli are obtained when the outer pre-impregnated CF UD layers are disposed perpendicularly to the layer stacking directed with higher stress retained at strains of 5% or 8% as compared when all the layers are mono-directionally oriented (Example 7 as compared to Example 6).

### Example 2: Visual Characterization of the Inner Structure of Composites of the Invention as Compared to Comparative Examples

Structures of the composites of the invention were analyzed by microscopy of cross sections of a laminate of Example 1 as compared to a laminate of a composite from comparative example (Comp. Ex. A). FIG. 4 presents photographs of cross-sections as observed by microscopy described above.

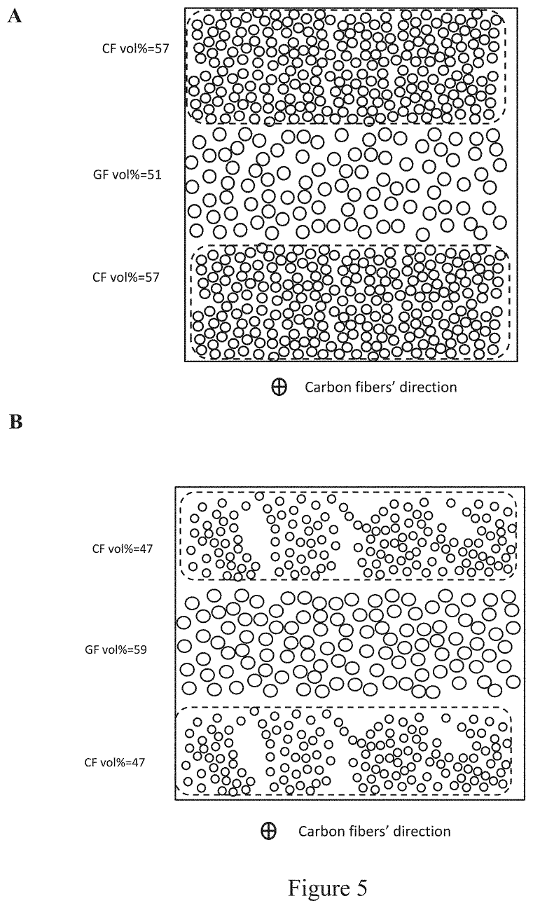

As can be seen on FIG. 4A, more resin is observed within CF regions and less within the GF layer (5B) in the laminate of the composite of the invention. The cross section of a laminate of the invention can be schematized as represented on FIG. 5B. In general, for laminates of the invention, within the CF bundles between 43 and 49 vol % CF are observed as compared to comparative examples where between 54 and 66 vol % CF are observed in the CF regions (FIG. 5A). In FIGS. 4 and 5, the total resin weight percent within the laminates are about 30 wt %, and the total weight percent carbon relative to the total weight of the laminates are about 40-43 wt %

In the laminates of comparative examples however, the molten resin films take the preferred path in early stages of melt pressing migrating to the more polar and porous glass fabric regions first, and thus the glass fabric regions have a higher resin fraction than in the laminates of composite of the invention (FIG. 5A).

This lower CF vol % within the representative carbon fiber regions in the laminate made of non-pre-impregnated carbon fibers makes these CF bundles tougher and much less sensitive to premature in-plane splitting of the CF bundles delamination leading to early catastrophic failure during flex observed for comparative examples (FIG. 1).

Those data support that in composite of the invention where the CF bundles are already pre-impregnated with the thermoplastic resin, during thermal pressing of the layers, capillary forces trap the resin within the tape and keep it from migrating out into the glass fabric regions.

Further, the formation of repeating micromorphology pattern of CF and resin within the CF layer(s) along a direction perpendicular to the carbon fibers axis in which carbon fiber represents between 35 and 49 vol % in the representative carbon fiber regions of the composite of the invention are believed to explain the improved stiffness and strain to failure as compared to known composites.

### Example of a Finished Product Made of a Composite Material of the Invention and Comparative Examples

In order to compare the performance of a beam made of a composite of the invention with a bean made of a composite of comparative examples, the following tests were made.

The beam structures were molded from a composite sheet and used to study the mechanical properties including the force needed to fracture, the beam compliance or stiffness, the displacement needed to reach peak load and subsequent load and displacement evolution after peak load until major failure of the beam structure. A series of beams were prepared as described below.

All materials were prepared for lamination using an isobaric double belt press (DBP) manufactured by the company Held. The machine is well known in the art and consists of two counter rotating steel belts driven by drums that move the material into the machine between the belts. Pressure is applied via a fluid to the belt and is hydrostatic in nature. The starting form of materials, here alternating stacks of fibrous material and film, will be subsequently described. These pass into the entry zone of the DBP where pressure is applied and the material heated from hot zones inside the DBP. The material then passes into a cooled zone where the laminate is cooled, still under pressure, and the final impregnated material removed from the laminator, which is preferably substantially void free material. Typical pressures applied during lamination range from 10-80 bars, and more preferably 40-60 bars. Typical temperature set-points of the machine are 320-400° C. for such polyamide materials, more preferably 340-360° C. The exit temperature was set to between 50 and 120° C., which is set to optimize cooling and release from the DBP steel belts. The equipment used with our structures allows very rapid impregnation of the resin into the fiber bundles. Typical DBP press machine speeds were 1-3.5 m/min at the above conditions.

In order to allow the use of batch prepared samples rather than use of continuous roll forms of materials, the preparation of composite structures was made through packet lamination. The packet lamination trials were performed using the materials detailed in Table 1 and in the stacking sequences shown in Table 2. Packet lamination trials were performed by placing the desired stack of polymer films, woven glass fiber fabrics, and previously made unidirectional carbon/polyamide tapes (CF UD tape) or unidirectional carbon non-crimp fabrics (UD NCF) onto the DBP steel belt inside a rectangular cut out of an Aluminum sheet.

TABLE 1
Polymers

| | |
|---|---|
| P1 | PA66/6 (75:25) |
| P2 | PA66 |
| P3 | PA66/6 (50:50) |

Fibrous material

| | |
|---|---|
| F1 | Glass Fiber 2-2 twill weave 600 g/m² |
| F2 | Glass Fiber 2-2 twill weave 300 g/m² |
| F3 | Carbon Fiber UD NCF 150 g/m² (50k Zoltek PANEX 35) for |
| | comparative examples |
| F4 | CF UD tape 0.19 mm, 48% Vf (P1 with 12k Toray T700), void |
| | content 6-8% as made |

TABLE 2

| | | | | |
|---|---|---|---|---|
| | | | CF Vf | |
| | | | over | |
| | | | laminate | |
| | | Vf, | volume | Thick- |
| Examples | Stacking sequence | % | % | ness, mm |

Comparative material: Carbon fiber (UD NCF) glass fiber-based material

| | | | | |
|---|---|---|---|---|
| Ex13 | P1/F1/P1/F3/P1/F3/P1/F3/P1/ | 48 | 16.8 | 1.48 |
| | F1/P1 | | | |
| Ex 14 | P1/F2/P2/F3/P2/F2/P2/F3/P2/ | 46 | 16.2 | 1.54 |
| | F2/P2/F3/P2/F2/P1 | | | |
| Ex 15 | P1/F3/P2/F2/P2/F3/P2/F2/P2/ | 45 | 22 | 1.51 |
| | F3/P2/F2/P2/F3/P1 | | | |
| Ex 16 | P1/F3/P1/F1/P1/F1/P1/F3/P1 | 42 | 11 | 1.51 |

Comparative material: glass fiber-based material

| | | | | |
|---|---|---|---|---|
| Comp K | P3/P1/F1/P1/F1/P1/F1/P1/P3 | 43 | 0 | 1.5 |

Comparative material: Pure Carbon fiber UD tape-based material

| | | | | |
|---|---|---|---|---|
| Comp L | F4 [90/0/90/0]s | 48 | 100 | 1.52 |

Material of the invention: Carbon fiber (UD Tape) glass fiber-
based material

| | | | | |
|---|---|---|---|---|
| Ex 17 | P1/F2/F4/P1/F2/F4/F2/F4/ | 47 | 17.5 | 1.58 |
| | F2/P1 | | | |
| Ex 18 | P1/F1/F4/F4/F4/F4/F1/P1 | 53.5 | 23.7 | 1.55 |

The laminate stacks were hence prepared, dried, and sealed in moisture proof bags. Upon lamination, the bags were opened at the entrance of the laminator and were then laminated using the isobaric DBP machine with a peak temperature of 360° C. and at a pressure of 40 bar. The exit temperature was set to either 80° C. or 120° C. Laminate void contents were below 2% after lamination.
Comparative example K (Comp K) is a glass based beam which was made using continuous lamination trial, also with a DBP. Comparative example (Comp L) is a pure carbon fiber UD tape beam which was made by stacking layers of CF UD tape, F4, using an automated deposition machine produced by the company Fiberforge to the stacking sequence shown in Table 2 above with local ultra-sonic welding to attach the layers together. A subsequent hot/cold press batch pre-consolidation step (hot side at 280° C., cold side at 180° C., pressure hot side 1.7 bars, cold side 12 bars, dwell time at temperature under pressure 350-400 s hot side, 60 s cold side) was used to melt the layers of tape together and to reduce the void content of the stacked UD tape to below 2%.

Voids were measured according to ISO7822 1990(en) following method C, Statistical counting. Samples were prepared for optical microscopy by embedding in resin and polishing to give clear contrast between fiber, resin, and voids. Images were taken using an Olympus optical microscope with automatic X-Y-Z stage to capture multiple images of the sample. An area of the full thickness and 15-25 mm length was imaged with sufficient resolution to detect both intra-bundular and inter bundular voids. The voids were then counted by segmenting the grey scale image into a binary image, where all features except voids were removed, and the void area automatically counted using “Analysis” software.

The laminate made was then trimmed to suit the beam tool dimensions using a KMT 6-axis robotic water jet cutter.

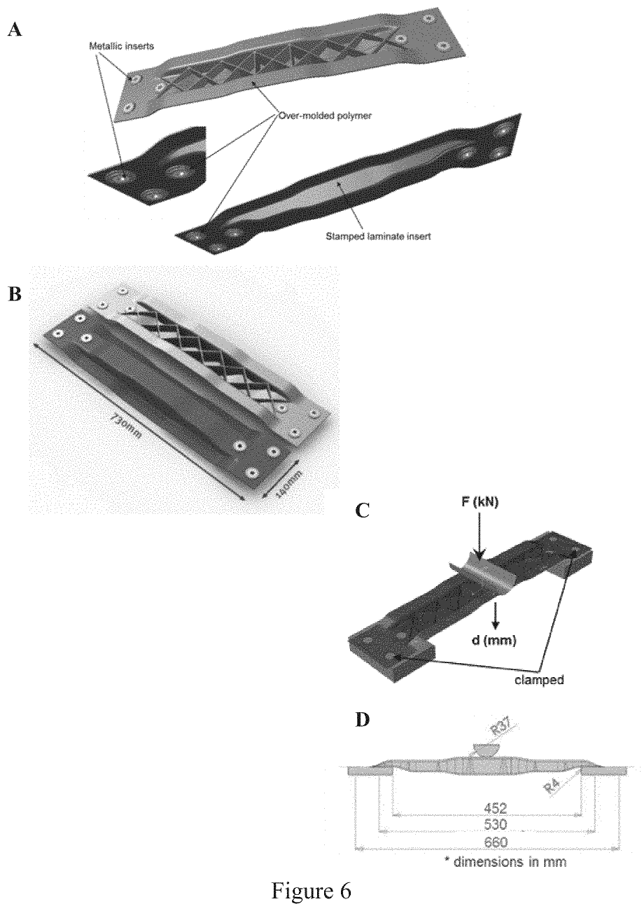

Beams were then molded from the flat sheet materials produced above, with the combinations of over-mold and laminate shown in Table 4. The generic beam structure is depicted in FIG. 6 with the key dimensions of a length of 730 mm, an upper rib thickness of 2 mm, a width of 140 mm, a laminate shell thickness of 1.5 mm that is over-molded with 1.5 mm of over-molding polymer with a height of 15 mm, 30 mm, and 50 mm at the different steps as shown on FIG. 6A.

The beam has a width to depth to length ratio of 9.3, 4.7, and 2.8 as examples of such structures. The width to depth ratio could be increased by removing the flanges, or the depth increased within the limits of designing such a tool as is well known in the art. The depth is required to give a sectional stiffness, a width is required for a torsional stiffness, and where the width to depth ratio is selected to be practical from a molding tool design perspective as is well known in the art and still offering interesting combinations of bending and torsional stiffness as is needed by the many applications that this component demonstrates. The structure also demonstrates the flexibility of composite sheet processing where a channel section of varying height and constant width can be formed. Additionally, the structure also demonstrates the integration of fully or partially over-molded structures to incorporate features to control buckling of the shell structure upon bending or torsion, incorporate features to introduce or control loads for example via metallic inserts, and other features that can be integrated by the over-molding polymer to provide advantageous functional integration and reduction of assembly costs in such components.

The molding operation in this example comprises two principle steps:

### Stage1:

Composite sheets were cut to a size of 890×340 mm to suit the molding tool. The stamp-forming molding tool consisted of a constant 1.5 mm section steel tool, tempered by water heater/chillers such that a desired temperature could be maintained, where 140° C. was used in these experiments suited to the specific polymer formulation being used. The tool is guided by location pins and heal blocks, as is well known in the art to ensure accurate guidance of the tool during closure. The molding tool was mounted in a vertical hydraulic press with down-stroking hydraulics and fast acting hydraulic accumulators to ensure rapid closure and pressure build up. The sheet materials were located inside a blank holder frame that was mounted to an electrically driven-servo sled. The sled loaded the materials into a fast acting medium wave infra-red oven where the sheet was heated to 290-300° C., with the temperature controlled by infra-red pyrometers. The sled was then programmed to move rapidly from the IR oven to above the steel stamping tool, with a transfer time of typically 8s from leaving the oven to when the press molding tool was closed. A force of 1800 kN was applied for 30s to ensure consolidation, crystallization and cooling under pressure, before the tool was opened and the stamped part was removed. An alternative to the use of the blank-holder and sled is the use of pick-and-place robots, for example 6-axis robots, and needle grippers. The stamped shell structure was then removed from the molding tool and trimmed to the shape of the second stage over-molding tool.

### Stage 2:

The stamped composite sheet was then taken to an over-injection molding cell comprising conveyors, a 6 axis robot with vacuum gripper, a warming oven, an Engel 700T injection molding press, and an injection molding tool. The stamped composite sheet forming the structural insert for the beam tool was warmed to 220-230° C. in the warming oven prior to rapid robotic transfer to the open over-injection tool. Typical transfer times for Ex 13 to Ex 18 and Comp L were 13s and C1 7s. Over-molding resin was then over-injected onto the stamped insert such that healing occurred between the two polyamide compositions to give an integral part. An injection pressure of nominally 500 bars was used with an injection tool temperature of 120° C. and a hold time of 30s as is typical of the normal range used in the art to injection mold polyamide resins. A delayed injection pattern was used to move the weld line away from the center of the beam using the 4 hot runner injection point control system. The over-molded beam was then removed from the molding tool and packaged in a dry bag to maintain the as molded moisture level prior to test.
As is well known in the art, such beams could also be prepared by the so called one step process where the composite sheet is heated to above its melting temperature, for example to 290° C., where forming then occurs directly in the horizontal or vertical over-injection molding machine as the tool (for example at 140° C.) closes and molten over-mold resin is injected directly onto the stamping.
Another alternative processing route is the combination of sheet forming and D-LFT processes. Here the composite sheet is heated using an IR oven. In parallel, an extruder is used to compound dry fiber and matrix resin or pellets of pre-compounded fiber and resin which are then extruded using a die into a molten log. The molten log is then transported with the heated composite sheet, preferably by robot, into a steel molding tool mounted in a vertically acting hydraulic press, for example as exemplified by equipment supplied by the company Dieffenbacher which is well known in the art.

In order to demonstrate the advantages of the composite structures exemplified by the beam structure, the beams were tested in a mechanical laboratory according to the sequence defined below.

Beams were tested using an Instron servo-hydraulic universal testing machine with extended testing bed. Solid steel supports were fabricated and the beams were fixed to the support plates using 6× steel bolts at each end which were tightened with a torque wrench. A force was applied to the center of the beam with a loading nose of radius 37 mm. The test supports had a radius of 4 mm, and the test span was 452 mm as shown in FIGS. 6C and D. Tests were performed at 23° C.

Table 3 details below the results of the mechanical tests made on comparative examples Ex 13 to Ex 16 and Comp K and L and Examples Ex 17 Ex 18. It can be seen that from Ex 13 to Ex 17/Ex 18 or Comp L there is increased beam peak load, increased compliance, and increased energy at peak load and at major failure compared with the glass based beam Comp K, as would be expected.

The full carbon fiber beam (Comp L) would be expected to offer the highest compliance and peak load. Using the same over-molding resin, examples Ex 17 and Ex 18 which use UD tape (F4) as the type of carbon fiber polyamide material, show increased properties compared with the comparative example Comp L while only using a limited proportion of carbon fiber as detailed in Table 2.

It can be seen that the use of UD tape contributes to a tough behavior by comparison of examples Ex 13 (using UD non-crimp fabrics) and Ex 18 (using UD tape). This is more than can be explained by a change in the CF fiber type as failure in the beam structure is multi-faceted with central beam collapse, side wall shear failure, and end region rip-through rather than simple linear strains, i.e. the form of UD dominates over the type of CF used and failure of the ply layup is what is contributing to the increased energies rather than the higher failure strain of the CF used in F4. Hence Ex 18 shows a greater than 2× increase in energy at peak load and at major failure.

A second comparison between the use of UD NCF (F3) and UD tape (F4) in hybrid-glass carbon beam structures can be seen by examining Ex 14 and Ex 17. Peak loads are similar as are displacement to peak loads. However the energy to major failure is increased for Ex 17 using UD CF tape (F4) due to the tough behavior of the laminate stack.

TABLE 3

| | | | | | | |
|---|---|---|---|---|---|---|
| | | | | Displacement | Energy | |
| | Peak | Displacement | Energy to | at major | at major | |
| | load, | at peak load, | peak load | failure | failure | Compliance |
| Example | (kN) | (mm) | (J) | (mm) | (J) | (kN/mm) |

Comparative material: Carbon fiber (UD NCF) glass fiber-based material

| | | | | | | |
|---|---|---|---|---|---|---|
| Ex 13 | 21.4 | 38.5 | 409.8 | 38.7 | 415.8 | 1.19 |
| Ex 14 | 24.1 | 42.7 | 519.9 | 43.6 | 538.5 | 1.23 |
| Ex 15 | 21.6 | 38.9 | 420.1 | 40.2 | 443.0 | 1.33 |
| Ex 16 | 17.9 | 36.3 | 336.5 | 36.3 | 337.0 | 1.08 |

Material of the invention: Carbon fiber (UD Tape) glass fiber-based material

| | | | | | | |
|---|---|---|---|---|---|---|
| Ex 17 | 26.5 | 48.6 | 660.3 | 56.2 | 852.2 | 1.25 |
| Ex 18 | 23.8 | 68.8 | 1056.1 | 78.9 | 1262.3 | 1.28 |

Comparative material: glass fiber-based material

| | | | | | | |
|---|---|---|---|---|---|---|
| Comp K | 15.9 | 38.4 | 299.1 | 38.4 | 300 | 0.47 |

Comparative material: Pure Carbon fiber UD tape-based material

| | | | | | | |
|---|---|---|---|---|---|---|
| Comp L | 26.0 | 44.1 | 593.9 | 52.4 | 762.3 | 1.2 |

In this test, conventional glass fiber beams typically fracture in the beam center with a catastrophic failure as the glass laminate fails at the beam center. This results in a sudden drop in load. Carbon fiber laminate beams, while stiffer, also show the same failure type with central catastrophic failure.
As opposed, the beams made of laminates of the composite of the invention present equivalent stiffness to a full carbon fiber beam (due to the direction properties in said beam), with a significant increase in energy absorption than both glass and carbon beams alone which is useful in a wide variety of industrial, automotive, etc. applications where shell structures of stamp-formed sheet material can be over-molded either locally or globally with over-molding resins to make rib stiffened shell structures.

Further, when cost and weight specific properties are examined, the beams with glass-carbon composite of the invention still offer a better way to gain stiffness and energy for a given cost and weight than both glass fiber and carbon fiber beam alone. This unexpected combination of advantageous mechanical properties and reasonable manufacturing cost of the beams made of glass-carbon composite of the invention are due to the fact that glass-carbon composite of the invention sheets not only have excellent directional mechanical properties, but it also use the lowest cost material forms, namely simple glass fiber weaves, and uni-directional carbon fiber (rather than more expensive carbon fiber weaves or other such structures).

For further illustration, additional non-limiting embodiments of the present disclosure are set forth below.

For example, embodiment 1 is a process for preparing a glass and carbon fiber composite structure comprising: stacking at least one layer of fibrous material made of glass fibers against at least one layer of unidirectional (UD) carbon fiber tape, the UD carbon fiber tape comprising unidirectional carbon fibers pre-impregnated with a thermoplastic resin; applying heat at a temperature adapted to melt the thermoplastic resin; applying pressure to the heated stacked layers to bond together and fully impregnate both carbon fiber and glass fiber layers in resin; and subsequently cooling the stacked layers to harden the thermoplastic resin to form said composite structure.

Embodiment 2 is the process of embodiment 1 wherein composite structure comprises between 2 to 4 layers of fibrous material made of glass fibers.

Embodiment 3 is the process of any one of embodiments 1 to 2 wherein the composite structure comprises at least 2 consecutive layers of UD carbon fiber tape on the outer surface of the composite structure.

Embodiment 4 is the process of any one of embodiments 1 to 3 wherein each layer of fibrous material made of glass fibers has a basis weight greater than 190 g/m² and less than 800 g/m².

Embodiment 5 is the process of any one of embodiments 1 to 4 wherein each layer of fibrous material made of glass fibers has a basis weight between 250 g/m² and 650 g/m².

Embodiment 6 is the process of any one of embodiments 1 to 5 wherein each layer of resin impregnated unidirectional (UD) carbon fiber tape has a basis weight greater than 90 g/m² and less than 450 g/m².

Embodiment 7 is the process of any one of embodiments 1 to 6 wherein the stacking step comprises stacking a plurality of layers of fibrous material comprising at least two resin impregnated unidirectional (UD) carbon fiber tapes and at least one glass fiber layer sandwiched between said at least two UD carbon fiber tapes, and wherein after the cooling step the volume percentage of carbon fiber relative to the total volume in representative carbon fiber regions comprising at least 300 fibers is in the range of between 35 and 49 vol % carbon fiber.

Embodiment 8 is the process of embodiment 7 wherein after the cooling step the volume percentage of carbon fiber relative to the total volume in representative carbon fiber regions comprising at least 300 fibers is in the range of between 39 and 47 vol % carbon fiber, and a volume fraction of glass to total fiber volume fraction within the entire laminate is less than 0.6.

Embodiment 9 is a composite material structure obtained by the process of any one of embodiments 1 to 8.

Embodiment 10 is a composite material structure comprising a plurality of stacked layers of fibrous material embedded in a resin, said plurality of layers of fibrous material including at least two carbon fiber layers and at least one glass fiber layer sandwiched between said at least two carbon fiber layers, a volume fraction of glass to total fiber volume fraction within the composite material structure being less than 0.6, wherein the carbon fiber layers originate from a resin impregnated unidirectional carbon fiber tape, and wherein a volume percentage of carbon fiber relative to a total volume, within a continuous region of the composite structure encompassing at least 300 carbon fibers and comprising essentially only carbon fibers and resin, is in the range of between 35 and 49 vol % of carbon fiber.

Embodiment 11 is the composite material structure of embodiment 10 wherein the volume percentage of carbon fiber relative to the total volume, within a continuous region of the composite structure encompassing at least 300 carbon fibers and comprising essentially only carbon fibers and resin, is in the range of between 39 and 47 vol % carbon fiber.

Embodiment 12 is the composite material structure of any one of embodiments 10 to 11 comprising UD carbon fiber layers embedded in resin on opposed outer surfaces of the composite structure, presenting a flexural modulus of about 60 GPa or higher and a percentage retention of peak stress at 5% flex strain of at least about 60%.

Embodiment 13 is the composite material structure of any one of embodiments 10 to 11 comprising woven glass fabrics layers embedded in resin on opposed outer surfaces of the composite structure, presenting a flexural modulus of about 35 GPa or higher and a percentage retention of peak stress at 5% flex strain of at least about 20%.

Embodiment 14 is a composite material structure comprising a plurality of stacked layers of fibrous material embedded in a resin, said plurality of layers of fibrous material including at least two carbon fiber layers and at least one glass fiber layer sandwiched between said at least two carbon fiber layers, wherein the carbon fiber layers originate from a resin impregnated unidirectional carbon fiber tape, and wherein the composite material structure is characterized by a flex modulus of 60 GPa or higher and a percentage retention of peak stress at 5% flex strain of at least 60%.

Embodiment 15 is the composite material structure of embodiment 14 wherein a volume percentage of carbon fiber relative to a total volume, within a continuous region of the composite structure encompassing at least 300 carbon fibers and comprising essentially only carbon fibers and resin, is in the range of between 35 and 49 vol % of carbon fiber.

Embodiment 16 is the composite material structure of any one of embodiments 14 to 15 wherein the volume percentage of carbon fiber relative to the total volume, within a continuous region of the composite structure encompassing at least 300 carbon fibers and comprising essentially only carbon fibers and resin, is in the range of between 39 and 47 vol % carbon fiber.

Embodiment 17 is the composite material structure of any one of embodiments 14 to 16 wherein the resin is a polyamide resin.

Embodiment 18 is the composite material structure of any one of embodiments 14 to 17 wherein each carbon fiber layer has a basis weight between 90 g/m² and 450 g/m².

Embodiment 19 is the composite material structure of any one of embodiments 14 to 18 wherein each glass fiber layer has a basis weight between 190 g/m² and 800 g/m².

Embodiment 20 is the composite material structure of any one of embodiments 14 to 19 wherein each glass fiber layer has a basis weight between 250 g/m² and 650 g/m².

Embodiment 21 is an article made of the composite material structure of any one of embodiments 14 to 20.

Embodiment 22 is an article incorporating the composite material structure of any one of embodiments 14 to 20.

1. A process for preparing a glass and carbon fiber composite structure comprising:
stacking at least one layer of fibrous material made of glass fibers against at least one layer of unidirectional (UD) carbon fiber tape,
the UD carbon fiber tape comprising unidirectional carbon fibers pre-impregnated with a thermoplastic resin,
applying heat at a temperature adapted to melt the thermoplastic resin,
applying pressure to the heated stacked layers to bond together and fully impregnate both carbon fiber and glass fiber layers in resin, and subsequently
cooling the stacked layers to harden the thermoplastic resin to form said composite structure.

2. A process according to claim 1 wherein the layer of fibrous material made of glass fibers is resin free prior to the heating step.

3. A process according to the claim 2 wherein the fibrous material made of glass fibers is woven.

4. A process according to either of the two directly preceding claims further comprising stacking at least one thermoplastic resin layer adjacent to said at least one layer of fibrous material made of glass fibers prior to the heating step.

5. A process according to any preceding claim wherein the amount of resin provided in the stacked layers is selected such that the composite structure has a resin weight fraction to total weight of between 25 and 40 wt %.

6. A process according to any preceding claim wherein the amount of fibrous material made of glass fibers provided in the stacked layers is selected such that the volume fraction of glass to total fiber volume fraction in the composite structure is less than 0.6.

7. A process according to any preceding claim wherein the carbon fiber content provided in the stacked layers is configured such that the carbon volume weight fraction relative to total volume of carbon fiber and resin within carbon fiber regions of the composite structure after the cooling step is between 35 and 49 vol %.

8. A process according to any preceding claim wherein the composite structure comprises a plurality of pairs of fibrous glass fiber and UD carbon fiber tape layers.

9. A process according to the preceding claim comprising stacking at least one thermoplastic resin layer adjacent to each layer of fibrous material made of glass fibers prior to the heating step.

10. A process according to any preceding claim wherein the composite structure comprises between 2 to 10 layers of UD carbon fiber tape.
